(19) United States
(12) Patent Application Publication
(10) Pub. No.: US 2025/0063480 A1
(43) Pub. Date: Feb. 20, 2025

(54) User Equipment (UE) Parallel Search in Connected Mode

(71) Applicant: Apple Inc., Cupertino, CA (US)

(72) Inventors: Saikat Sengupta, Bengaluru (IN); Bernd H. Kemmer, Eichenau (DE); Deepak Dash, Bengaluru (IN); Jayanth Nadigar, Bengaluru (IN); Parvez Sheikh, Bengaluru (IN)

(21) Appl. No.: 18/785,673

(22) Filed: Jul. 26, 2024

Related U.S. Application Data
(60) Provisional application No. 63/532,843, filed on Aug. 15, 2023.

(51) Int. Cl. H04W 48/16; H04W 84/04

(52) U.S. Cl. CPC H04W 48/16; H04W 84/042

(57) ABSTRACT

Disclosed are methods, systems, and computer-readable medium to perform operations including: receiving, by an access stratum (AS) layer of a user equipment (UE) and from a non-access stratum layer (NAS) layer of the UE, a Public Land Mobile Network (PLMN) search request; determining, by the AS layer, that a first connection instance is in radio resource control (RRC) connected mode; responsively determining, by the AS layer, whether a second connection instance is available; and in response to determining that the second connection instance is available, triggering, by the AS layer, the PLMN search on the second connection instance, wherein the PLMN search comprises one or more frequency scans.

### CROSS-REFERENCE TO RELATED APPLICATIONS

This application claims priority to U.S. Provisional Patent Application No. 63/532,843, filed Aug. 15, 2023, which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A public land mobile network (PLMN) refers to a network that is provided by an operator in a specific geographical area. A user equipment (UE) can perform PLMN searches when the UE is turned on or when it moves to a new location. PLMN searches can be triggered automatically by the UE or can be triggered manually, e.g., in response to a user input. During a PLMN search, the UE sends out signals to nearby base stations of to see identify networks that are accessible. In particular, the UE can “scan” frequency bands by sending signals on those bands to determine the PLMNs that are available on those bands.

In certain search procedures, frequency scans are split into a short list search (SLS) scan (also called Storage List Search), a derived band search (DBS) scan, a DBS_MCC scan, and a remaining band search (RBS) scan. The SLS scan may include the most recently used frequencies stored in the UE. The SLS scan can have a shorter duration than the DBS scan and hence may be performed at a faster rate. The DBS scan may be performed on bands to which the SLS frequencies correspond. The DBS scan may have a shorter duration than the RBS scan. In the DBS_MCC scan, UE searches the remaining of the country, Mobile Country Code (MCC), which was not searched in the DBS Scan. DBS_MCC scan is always scheduled after DBS scan. The RBS scan may be performed every “x” number of DBS scans or when a suitable cell is not found using the SLS or DBS scans. The RBS scans may include all remaining frequencies of all bands of a particular RAT.

### SUMMARY

In an example implementation, method to be performed by a user equipment (UE) involves: receiving, by an access stratum (AS) layer of the UE and from a non-access stratum layer (NAS) layer of the UE, a Public Land Mobile Network (PLMN) search request; determining, by the AS layer, that a first connection instance is in radio resource control (RRC) connected mode; responsively determining, by the AS layer, whether a second connection instance is available; and in response to determining that the second connection instance is available, triggering, by the AS layer, the PLMN search on the second connection instance, wherein the PLMN search comprises one or more frequency scans.

In an aspect combinable with the example implementation, the one or more frequency scans include at least one of a short list search (SLS) scan, a derived band search (DBS) scan, or a remaining band search (RBS) scan.

In another aspect combinable with any of the previous aspects, the method further including performing, by the AS layer and using the second connection instance, the PLMN search on available frequency bands that are not currently being used by the first connection instance or that are not in band conflict with the first connection instance; and providing, by the AS layer and to the NAS layer, a first set of PLMN search results detected on the available frequency bands.

In another aspect combinable with any of the previous aspects, the method further including determining, by the AS layer, that the first connection instance has transitioned to an RRC idle mode; responsively performing, by the AS layer and using the first or second connection instance, the PLMN search on a remaining set of frequency bands; and providing, by the AS layer and to the NAS layer, a second set of PLMN search results detected on the remaining set of frequency bands.

In another aspect combinable with any of the previous aspects, the method further including determining, by the AS layer and during the PLMN search, that the first connection instance has transitioned to an RRC idle mode; and responsively triggering, by the AS layer, at least one remaining frequency scan using the first connection instance.

In another aspect combinable with any of the previous aspects, the method further including detecting, by the AS layer, an activity on the second connection instance different from the PLMN search; and responsively aborting the PLMN search on the second connection instance.

In another aspect combinable with any of the previous aspects, the method further including sending, by the AS layer to the NAS layer, a message comprising: (i) an indication of frequency bands searched prior to aborting the PLMN search, and (ii) a list of identified PLMNs on the searched frequency bands.

In another aspect combinable with any of the previous aspects, the method further including resuming the PLMN search on the first connection instance.

In another aspect combinable with any of the previous aspects, the first connection instance is for a first radio access technology (RAT) and the second connection instance is for a second RAT.

In another aspect combinable with any of the previous aspects, the UE is a Multi-Subscriber Identity Module (MSIM) UE.

In another aspect combinable with any of the previous aspects, the first connection instance is provided by a first SIM and the second connection instance is provided by a second SIM

In another example implementation, a method to be performed by a user equipment (UE) involves determining to perform a Public Land Mobile Network (PLMN) search on a first connection instance; determining that the first connection instance is in radio resource control (RRC) connected mode; determining whether a second connection instance is available for the PLMN search; and in response to determining that the second connection instance is available, performing the PLMN search on the second connection instance, wherein the PLMN search comprises one or more frequency scans.

In an aspect combinable with the example implementation, the method further involves performing the PLMN search on available frequency bands that are not currently being used by the first connection instance or that are not in band conflict with the first connection instance; and identifying a first subset of PLMN search results detected on the available frequency bands.

In another aspect combinable with any of the previous aspects, the method further including determining that the first connection instance is in RRC idle mode; responsively performing, using the first or second connection instance, the PLMN search on a remaining set of frequency bands; and identifying a second subset of PLMN search results detected on the remaining set of frequency bands.

In another aspect combinable with any of the previous aspects, the method further including determining that the first connection instance is in RRC idle mode; and responsively performing at least one remaining frequency scan on the first connection instance.

In another aspect combinable with any of the previous aspects, the method further including determining that the second connection instance is unavailable for the PLMN search; and responsively aborting the PLMN search on the second connection instance.

In another aspect combinable with any of the previous aspects, the method further including identifying PLMNs found on searched frequency bands prior to aborting the PLMN search.

In another aspect combinable with any of the previous aspects, the method further including resuming the PLMN search on the first connection instance.

### BRIEF DESCRIPTION OF THE FIGURES

FIG. 1 illustrates a wireless network, according to some implementations.

FIG. 2 illustrates an example protocol stack, according to some implementations.

FIG. 3A and FIG. 3B illustrate example scenarios of a PLMN search being triggered while a UE is in RRC connected mode, according to some implementations.

FIG. 4A, FIG. 4B, and FIG. 4C illustrate scenarios of a UE parallel searching while in connected mode, according to some implementations.

FIG. 5A illustrates a flowchart of an example method, according to some implementations.

FIG. 5B illustrates a flowchart of another example method, according to some implementations.

FIG. 6 illustrates an example user equipment (UE), according to some implementations.

FIG. 7 illustrates an example access node, according to some implementations.

### DETAILED DESCRIPTION

In existing wireless communication systems, when a manual or an automatic Public Land Mobile Network (PLMN) search, e.g., a high priority PLMN search, is triggered while a user equipment (UE) is in radio resource control (RRC) connected mode, the search is either rejected or suspended until the RRC connection is released (e.g., the RRC connection moves to idle). This rejection can lead to unnecessary delays, and in the worst-case scenario, the UE may not perform the search at all.

With the introduction of Multi-Subscriber Identity Module (MSIM) and Dual Receive Dual SIM Dual Standby (DR-DSDS), a UE can support connectivity to multiple access nodes. The multiple access nodes may be of the same or different radio access technologies (RATs), such as Bluetooth™, Wi-Fi, Long-Term Evolution (LTE), New Radio (NR). Under MSIM and DR-DSDS, the UE can include multiple connection instances, e.g., in the access stratum (AS) layer and the non-access stratum (NAS) layer, that allow the UE to support the connectivity to multiple access nodes. In some examples, each connection instance is facilitated using a respective subscriber identity module (SIM). In these examples, each connection instance is referred to as the SIM instance. In the AS layer, each connection instance can connect to a different access node. For example, in the context of DR-DSDS, a UE can have two connection instances, e.g., a first connection instance for connecting to an NR RAT and a second connection instance for connecting to an LTE RAT.

This disclosure describes systems and methods for a UE performing parallel search in connected mode. To perform the parallel search in connected mode, the UE can leverage the MSIM and DR-DSDS features to perform a PLMN search while in RRC connected mode. In one embodiment, while the UE is in RRC connected mode in a current connection instance, the UE can perform a PLMN search using another connection instance. To do so, in the AS layer, the UE performs the PLMN search using a connection instance that is available while the current connection instance is unavailable. By performing the search using a second connection instance while a first connection instance is unavailable, the UE avoids the search delays or failures that occur in existing devices when attempting a PLMN search while in RRC connected mode.

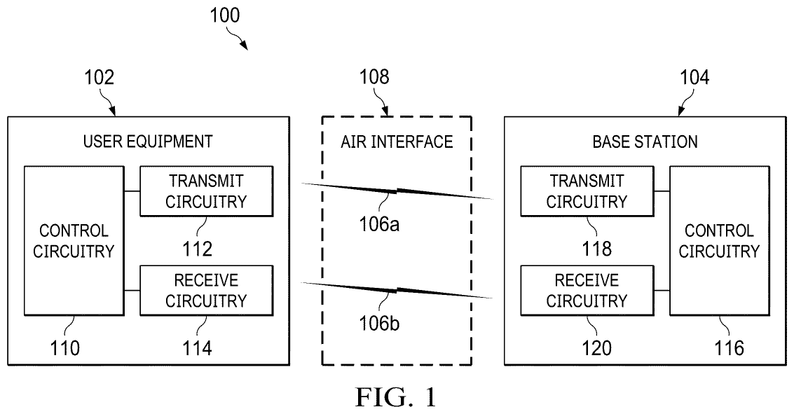

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network that incorporates Fifth Generation (5G) New Radio (NR) communication standards as defined by the Third Generation Partnership Project (3GPP) technical specifications. In other implementations, the wireless network 100 is a Non-Standalone (NSA) network that incorporates Long Term Evolution (LTE) and 5G NR communication standards. For example, the wireless network 100 may be a E-UTRA (Evolved Universal Terrestrial Radio Access)-NR Dual Connectivity (EN-DC) network, or an NR-E-UTRA Dual Connectivity (NE-DC) network. Furthermore, other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G.

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE.

The transmit circuitry 112 can perform various operations described in this specification. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

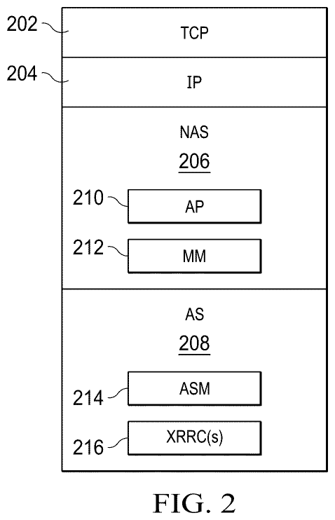

FIG. 2 illustrates an example protocol stack 200, according to some implementations. The protocol stack 200 can be implemented by a UE, such as the UE 102. As shown in FIG. 2, the protocol stack 200 can include a transport (TCP) layer 202, an IP layer 204, a non-access stratum (NAS) layer 206, and an access stratum (AS) layer 208, among other layers. The NAS layer 206 can include an access point (AP) manager 210 and mobility manager(s) (MM) 212. Among other things, the AP manager 210 is responsible for initiating PLMN searches (e.g., automatically or in response to a user input). And among other things, each MM 212 is responsible for mobility related actions, such as PLMN selection, for the UE on a particular connection instance. Specifically, a first MM is responsible for mobility related actions for a first connection instance, a second MM is responsible for mobility related actions for a second connection instance, and so on. Note that the different MMs can be numbered. For example, a first MM can be labeled as “MM0,” a second can be labeled as “MM1,” and so on.

As also shown in FIG. 2, the AS layer 208 includes an access stratum manager 214 that is, among other things, responsible for managing the RRC protocol for different connection instances (XRRC 216). For example, an RRC layer for a first connection instance, called NR RRC (NRRC), can be used to connect to an NR access node, and an RRC layer for a second connection instance, called LTE RRC (LRRC), can be used to connect to an LTE access node. Note that the different connection instances can be numbered. For example, the RRC layer of a first connection instance can be represented as XRRC0, the RRC layer of a second connection instance can be represented as XRRC1, and so on. In this disclosure, the a connection instance related to a particular radio access technology (RAT) is referred to as the connection instance of that RAT. Additionally, the respective layers and/or protocols associated with a particular connection instance are numbered with the same numbering as that connection instance. For example, For example, MM0 and XRRC0 are both associated with a first connection instance (e.g., SIM Instance 0).

In line with the discussion above, when a PLMN search is triggered in an existing UE while the UE is in RRC connected mode, e.g., for communicating packet-switched (PS) data, the search is either rejected or suspended until the existing RRC connection is released. The rejection or suspension can lead to unnecessary delays, and in the worst-case scenario, the PLMN search might not be performed at all.

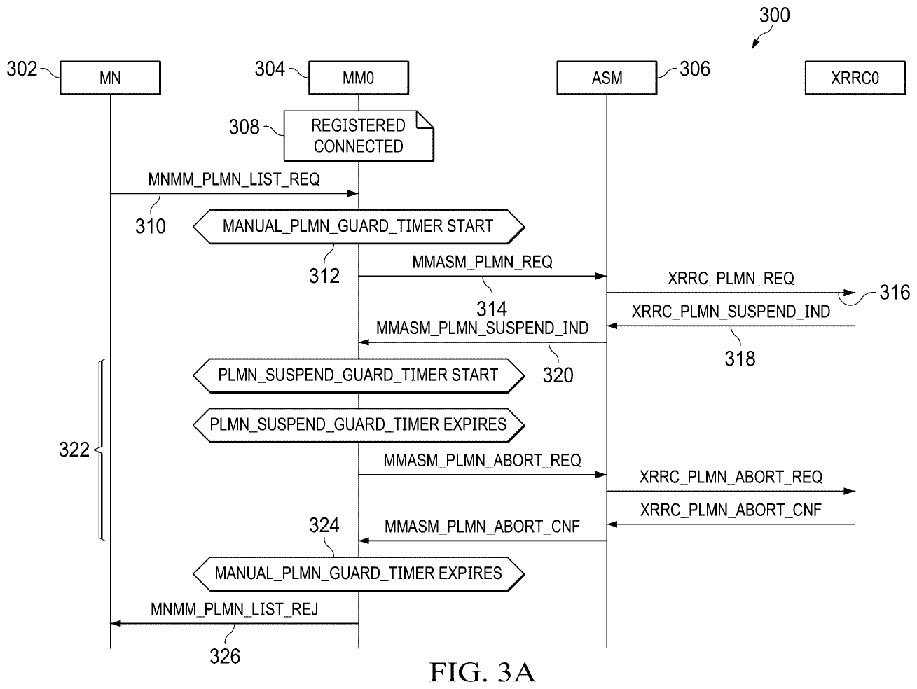

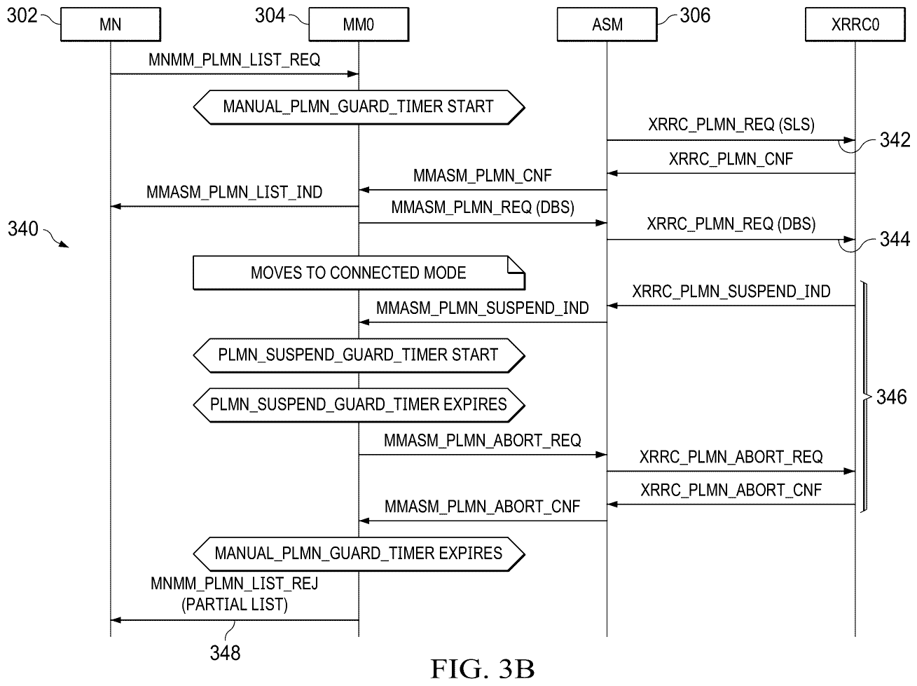

FIG. 3A and FIG. 3B illustrate example scenarios of a PLMN search being triggered while a UE is in RRC connected mode, according to some implementations. The entities involved in these scenarios include AP manager 302 (of the NAS layer), an MM 304 (of the NAS layer), an ASM 306 (of the AS layer). The RRC layer (of the AS layer) is represented as XRRC0.

Starting with scenario 300 of FIG. 3A, the UE is in RRC connected mode as shown by block 308. While in RRC connected mode, the MM 304 receives a PLMN list request 310 from the AP manager 302. In response to receiving the request, the MM 304 initiates a PLMN guard timer 312, which serves as an upper time threshold for attempting the PLMN search. The MM 304 then sends a PLMN request 314 to the ASM 306. The ASM 306 forwards a PLMN request 316 to XRRC0. Because XRRC0 is in RRC connected mode, XRRC0 responds with a PLMN search suspend message 318. In response to receiving the PLMN search suspend message 318, the ASM 306 sends a PLMN suspend message 320 to the MM0. The MM0 then initiates an abort procedure 322. The PLMN guard timer 312 then expires at 324 without the PLMN search being performed. Because the PLMN guard timer 312 expires without the PLMN search being performed, the MM 304 sends a PLMN list reject message 326 to the AP manager 302.

Turning to the scenario 340 of FIG. 3B, the AP manager 302 initiates a PLMN search prior to the UE being in RRC connected mode. After the PLMN search is initiated, in step 342, an SLS scan is performed and the results are provided to the AP manager 302. Then, a DBS scan is initiated at step 344. However, prior to the DBS scan being completed, the UE moves to RRC connected mode. As a result, the DBS search is suspended and the PLMN search is aborted, as shown by messages 346. The MM 304 provides the AP manager 302 with a partial list 348 of PLMN search results (e.g., from the SLS scan and/or the partial DBS scan).

As illustrated by these scenarios, when a PLMN search is triggered or is performed while a UE is in RRC connected mode, the search is either rejected or suspended until the existing RRC connection is released. This disclosure describes systems and methods that enable a UE to perform parallel search in connected mode, particularly in scenarios where the UE has more than one connection instance (e.g., more than one SIM instance facilitated by multiple SIMs).

In some implementations, when a PLMN search is triggered while a UE is in RRC connected mode in a first connection instance, the UE is configured to initiate a PLMN search using a second connection instance. More specifically, when a PLMN search is triggered while a first instance is in RRC connected mode, a UE is configured to use a radio frequency (RF) resource allocation of a second instance to perform the PLMN search. The RF allocation of the second instance may be different than an RF allocation of the first instance. When the UE detects that a PLMN search is triggered on a first connection instance that is in RRC connected mode, the UE is configured to trigger the PLMN search on a second connection instance that has no ongoing activity (e.g., is in RRC idle mode). Then, the second connection instance provides the results of the PLMN search to the first connection instance for further handling (e.g., MM0). If the second connection instance has ongoing activity, however, the UE is configured to search using the first connection instance (or perhaps another connection instance) based on opportunity.

In some implementations, an ASM is configured to monitor for a PLMN search being triggered on a current connection instance. In particular, an AP manager sends a PLMN search request to a MM of the current connection instance, e.g., MM0, which in turn, sends a request to the ASM. In response to determining that a PLMN search has been triggered, the ASM checks the connection status of the current instance, e.g., XRRC0. If the current instance is in RRC idle mode, the ASM triggers the PLMN search on that current connection instance. Conversely, if the current connection instance is in RRC connected mode, the ASM is configured to check the status of a second connection instance. If there are no ongoing procedures on XRRC1 (e.g., the connection instance is in RRC idle mode or has no ongoing activity, etc.), the ASM is configured to trigger the PLMN search on XRRC1.

In some implementations, the UE performs frequency scans using XRRC1 once the PLMN search is triggered on XRRC1. In particular, the UE scans the frequency bands of the RF allocation of XRRC1. Once XRRC1 performs the frequency scans, XRRC1 reports the results to the ASM, which in turn, reports the results to the first connection instance, e.g., MM0. The MM0 then provides a list of the PLMN search results to the AP manager.

Although the UE can scan the frequency bands of the RF allocation of XRRC1, the UE cannot scan the frequency bands of the RF allocation of XRRC0 since that RF allocation is currently being used. For such bands, XRRC1 returns an incomplete PLMN list to the ASM. Later, the ASM can instruct XRRC0 or XRRC1 to scan those bands once XRRC0 stops using them.

In some implementations, if XRRC0 switches to RRC idle mode while the XRRC1 is still performing the PLMN search, the ASM is configured to trigger the remaining incomplete frequency scans on XRRC0. Specifically, once XRRC1 reports the results of the current frequency scan, the ASM instructs XRRC0 to perform the remaining frequency scans that were not performed by XRRC1 (if any).

In some implementations, if a request is triggered on XRRC1 while it is performing the PLMN search, the ASM is configured to instruct XRRC1 to abort the PLMN search. The ASM then reports the searched bands and the already found PLMNs to MM0. Then, the ASM falls back to legacy behavior (e.g., performing the PLMN search using XRRC0 once the ongoing procedures are completed).

Note that in existing systems, if a first connection instance (XRRC0) is in PS connected mode and a manual PLMN search is initiated on a second connection instance (XRRC1), the ASM suspends data on XRRC0 as the manual PLMN search has a higher priority. The ASM then causes the UE to transition to a Single Receive Dual SIM Dual Standby (SR-DSDS) mode of operation instead of DR-DSDS. Note that SR-DSDS is a more limited mode of operation than DR-DSDS.

In some implementations, as part of the disclosed methods and systems, when a manual PLMN is triggered on a second connection instance, the ASM is configured to perform an exception to the existing configuration. Thus, the UE can continue to operate in DR-DSDS mode.

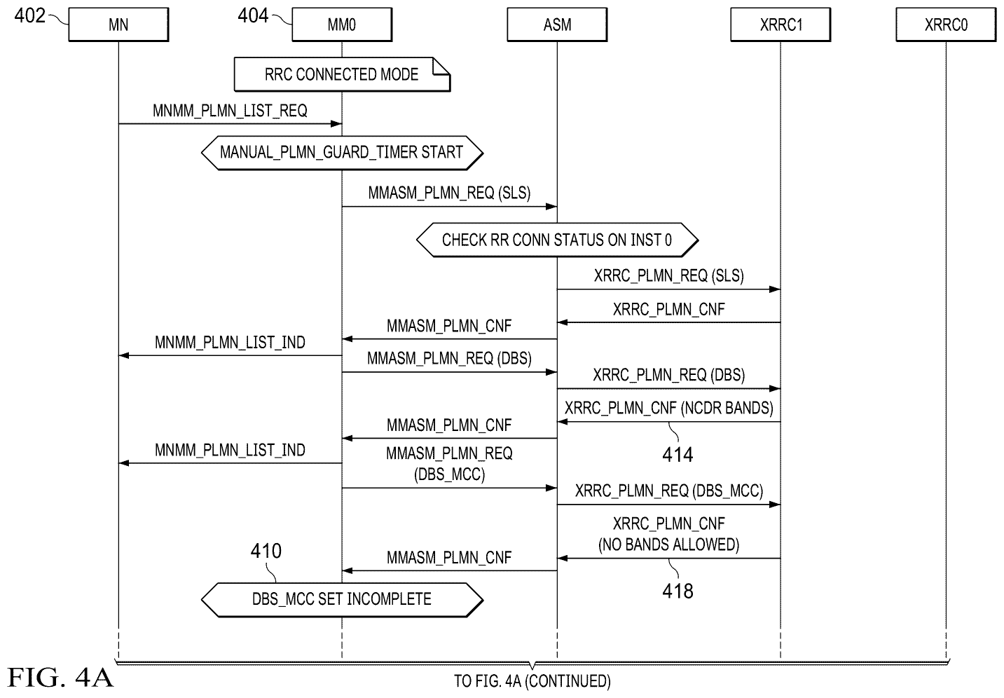

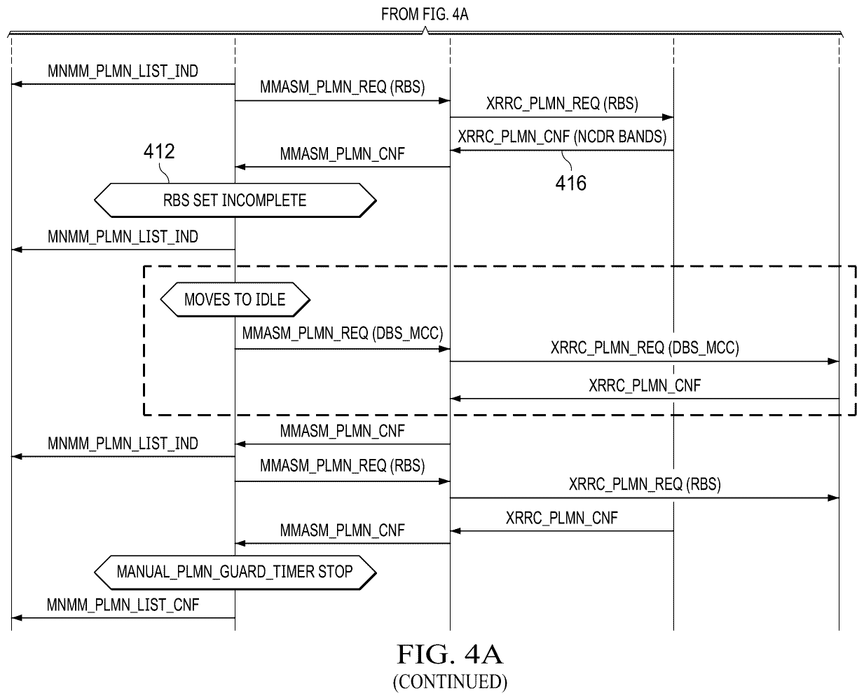

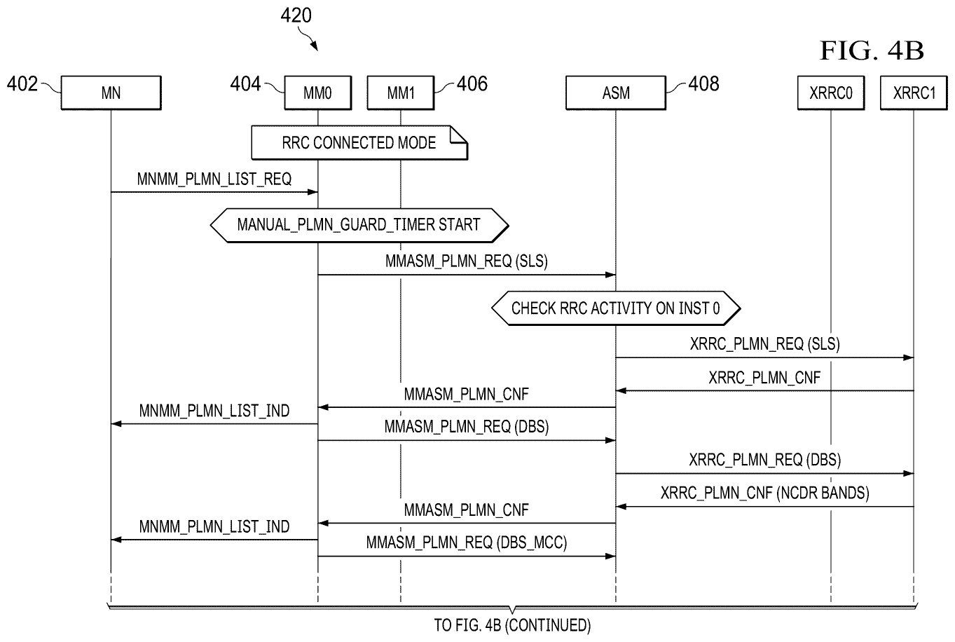

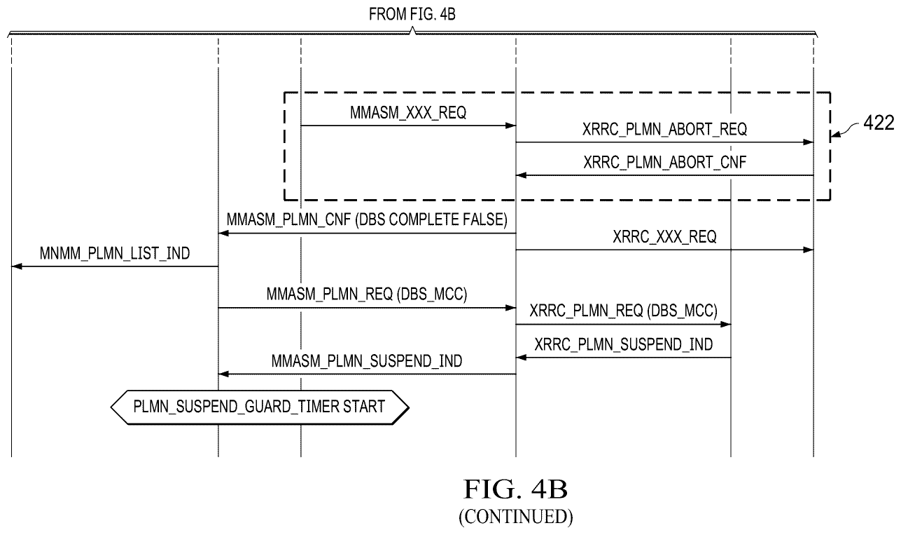

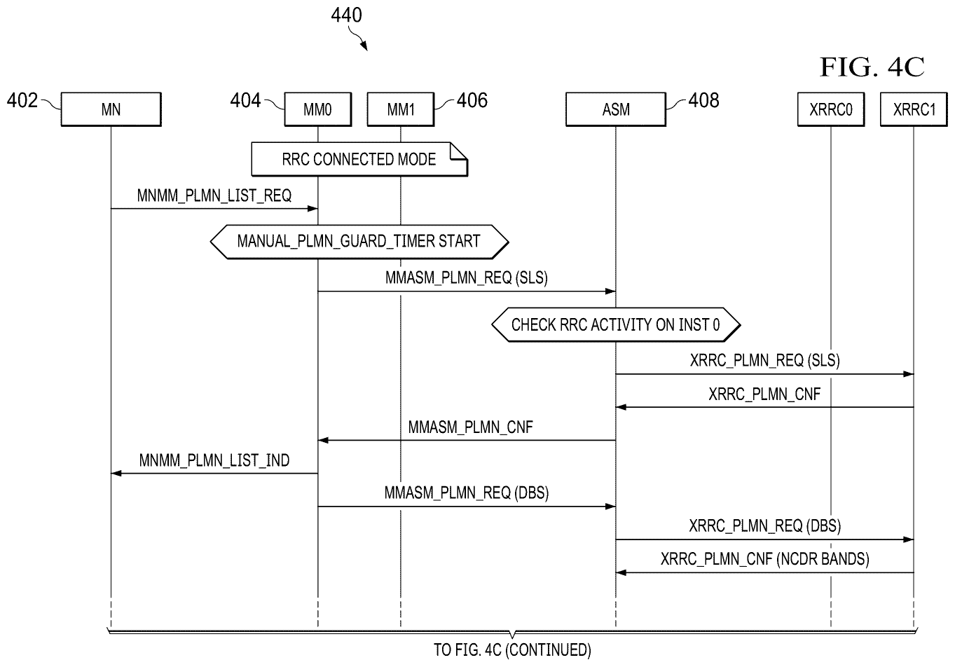

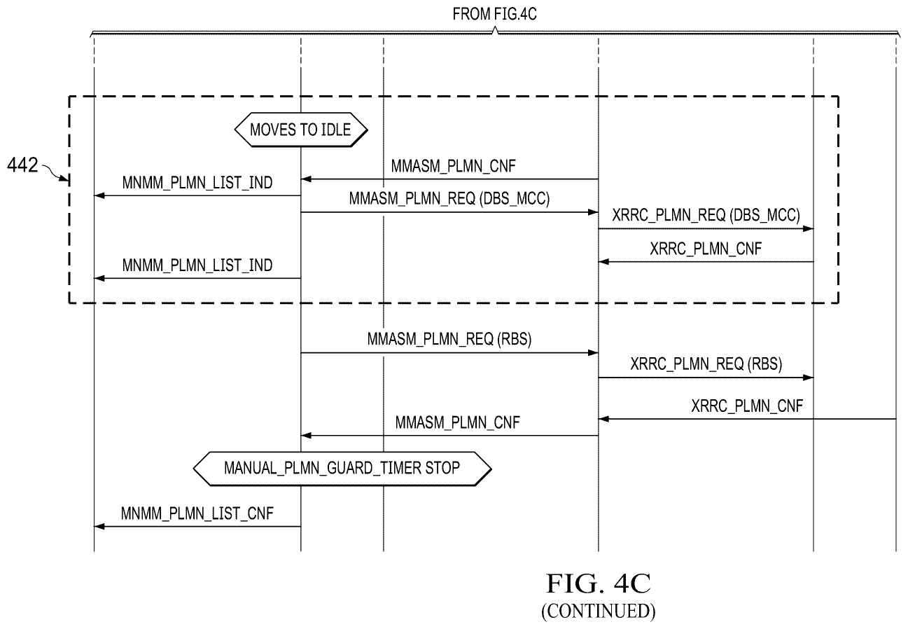

FIG. 4A, FIG. 4B, and FIG. 4C illustrate scenarios, e.g., scenario 400, scenario 420, and scenario 440, of a UE parallel searching while in connected mode, according to some implementations. These scenarios are described using sequence diagrams. The actions in these scenarios can be performed by protocol stack of a UE, including: an AP manager 402, a first MM 404, also called MM0, for a first connection instance, a second MM 406, also called MM1, for a second connection instance, and an ASM 408. The RRC layer of the first connection instance is represented as XRRC0 and an RRC layer of a second connection instance is represented as XRRC1. The first connection instance may connect to a first RAT (e.g., NR RAT) and the second connection instance may connect to a second RAT (e.g., LTE RAT). Alternatively, the different connections may connected to access nodes of the same RAT.

In the following scenarios, the frequency scans of a PLMN search are performed in the following order: an SLS scan, a DBS scan, a DBS_MCC scan, an RBS scan. Different orders of frequency scans are also possible.

Turning to FIG. 4A, the scenario 400 involves the AP manager 402 determining to perform a PLMN search in a first connection instance. The AP manager 402 sends the MM0 a PLMN search request. In response to receiving the search request, the MM0 starts a PLMN guard timer. Then, the MM0 sends a request to the ASM 408 to perform an SLS scan in connection with the PLMN search. In response to receiving the request, the ASM 408 determines a status of the current connection instance (the first connection instance). In this scenario, the current instance is in RRC connected mode. In response to determining that the current instance is in RRC connected mode, the ASM 408 checks the status of a second connection instance. If there are no ongoing procedures on the second connection instance, then the ASM 408 triggers the PLMN search on the second connection instance, XRRC1.

More specifically, the ASM 408 performs the SLS scan, the DBS scan, the DBS_MCC scan, and the RBS scan. As shown in FIG. 4A, however, the results of the DBS_MCC scan and the RBS scan are incomplete. This is because these scans involve scanning frequency bands on which XRRC0 is operating. Thus, as shown by blocks 410, 412, the results of the DBS_MCC scan and the RBS scan are marked as incomplete. In particular, the DBS_MCC scan and the RBS scan are performed on the Non-Conflicting Dual Receive (NCDR) Bands. In case of Dual SIM cases, when one SIM instance is performing any action, e.g., PS Data TX-RX in one scenario, the other SIM instance is allowed perform scans only on Non-Conflicting Bands to avoid TX-RX, RX-RX conflict scenarios. As shown by messages 414, 416, the results of the DBS and RBS scans include NCDR bands.

As shown in FIG. 4A, the results of the DBS_MCC scan include a “No Bands Allowed” message 418. In case the AS is not able to perform scan on some bands supported by the UE due to NCDR limitations, the AS provides the No Bands Allowed cause with searched band information and found PLMNs if any.

Later, the operations on XRRC0 cease, for example, by the XRRC0 moving to RRC idle mode. In response, the MM0 provides a request to the ASM 408 to complete the previously incomplete scans, e.g., the DBS_MCC scan and the RBS scan. The ASM 408 instructs the XRRC0 or the XRRC1 to complete the scans. In scenario 400, the ASM 408 instructs XRRC0 to perform the incomplete scans. Thus, as shown in FIG. 4A, the DBS_MCC scan and the RBS scan are performed using XRRC0.

Moving to FIG. 4B, like in scenario 400, the UE in scenario 420 performs a PLMN search using XRRC1 in response to determining that XRRC0 has ongoing activity and XRRC1 does not. In scenario 420, however, after XRRC1 performs one or more scans, a request is triggered on the second connection instance. As shown in block 422, MM1 sends the ASM 408 a message related to the new request. As shown in the same block, in response to receiving the message, the ASM 408 aborts the PLMN search being performed on XRRC1. The ASM 408 sends MM0 a message indicating that the latest scan was incomplete. In turn, MM0 provides the AP manager 402 with the incomplete PLMN results (e.g., a list of the already found PLMNs). Further, the ASM 408 sends a message to XRRC1 to perform actions related to the new request.

Later, MM0 sends the ASM 408 a request to perform the previously incomplete one or more searches. Upon receiving the request, the ASM 408 falls back to a legacy procedure, e.g., performing the searches on XRRC0.

Turning to FIG. 4C, like in scenarios 400 and 420, the UE in scenario 440 performs a PLMN search using XRRC1 in response to determining that XRRC0 has ongoing activity and XRRC1 does not. In this scenario, XRRC1 performs the SLS scan and the DBS scan. During or after the DBS scan is completed, the first connection instance moves to RRC idle mode, as shown in block 442. The ASM 408 detects that the first connection instance has moved to RRC idle mode. In response, the ASM 408 instructs XRRC0 to perform the remaining scans. In scenario 440, the remaining scans include DBS_MCC and RBS. Thus, the ASM 408 instructs XRRC0 to perform these scans, as shown in block 442.

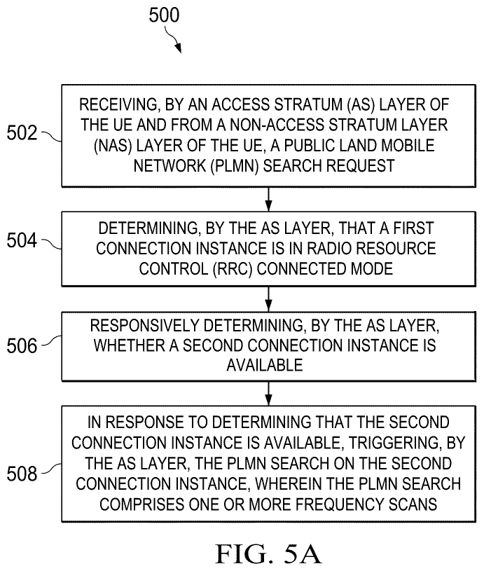

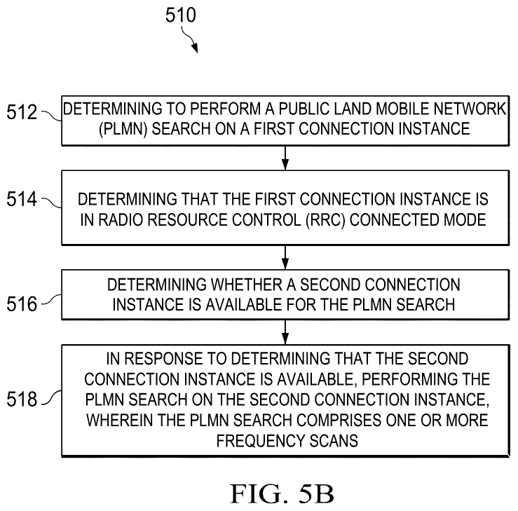

FIG. 5A illustrates a flowchart of an example method 500, according to some implementations. For clarity of presentation, the description that follows generally describes method 500 in the context of the other figures in this description. For example, method 500 can be performed by UE 102 of FIG. 1. The UE 102 may be a MSIM UE. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

At step 502, method 500 involves receiving, by an access stratum (AS) layer of the UE and from a non-access stratum layer (NAS) layer of the UE, a Public Land Mobile Network (PLMN) search request.

At step 504, method 500 involves determining, by the AS layer, that a first connection instance is in radio resource control (RRC) connected mode.

At step 506, method 500 involves responsively determining, by the AS layer, whether a second connection instance is available.

At step 508, method 500 in response to determining that the second connection instance is available, triggering, by the AS layer, the PLMN search on the second connection instance, wherein the PLMN search comprises one or more frequency scans.

In some implementations, the one or more frequency scans include at least one of a short list search (SLS) scan, a derived band search (DBS) scan, or a remaining band search (RBS) scan.

In some implementations, the method further involves: performing, by the AS layer and using the second connection instance, the PLMN search on available frequency bands that are not currently being used by the first connection instance or that are not in band conflict with the first connection instance; and providing, by the AS layer and to the NAS layer, a first set of PLMN search results detected on the available frequency bands.

In some implementations, the method further involves determining, by the AS layer, that the first connection instance has transitioned to an RRC idle mode; responsively performing, by the AS layer and using the first or second connection instance, the PLMN search on a remaining set of frequency bands; and providing, by the AS layer and to the NAS layer, a second set of PLMN search results detected on the remaining set of frequency bands.

In some implementations, the method further involves determining, by the AS layer and during the PLMN search, that the first connection instance has transitioned to an RRC idle mode; and responsively triggering, by the AS layer, at least one remaining frequency scan using the first connection instance.

In some implementations, the method further involves detecting, by the AS layer, an activity on the second connection instance different from the PLMN search; and responsively aborting the PLMN search on the second connection instance.

In some implementations, the method further involves sending, by the AS layer to the NAS layer, a message comprising: (i) an indication of frequency bands searched prior to aborting the PLMN search, and (ii) a list of identified PLMNs on the searched frequency bands.

In some implementations, the method further involves resuming the PLMN search on the first connection instance.

In some implementations, the first connection instance is for a first radio access technology (RAT) and the second connection instance is for a second RAT.

In some implementations, the UE is a Multi-Subscriber Identity Module (MSIM) UE.

In some implementations, the first connection instance is provided by a first SIM and the second connection instance is provided by a second SIM.

FIG. 5B illustrates a flowchart of an example method 510, according to some implementations. For clarity of presentation, the description that follows generally describes method 510 in the context of the other figures in this description. For example, method 510 can be performed by UE 102 of FIG. 1. The UE 102 may be a MSIM UE. It will be understood that method 510 can be performed, for example, by any suitable system, environment, software, hardware, or a combination of systems, environments, software, and hardware, as appropriate. In some implementations, various steps of method 510 can be run in parallel, in combination, in loops, or in any order.

At step 512, method 510 involves determining to perform a Public Land Mobile Network (PLMN) search on a first connection instance.

At step 514, method 510 involves determining that the first connection instance is in radio resource control (RRC) connected mode.

At step 516, method 510 involves determining whether a second connection instance is available for the PLMN search.

At step 518, method 510 involves in response to determining that the second connection instance is available, performing the PLMN search on the second connection instance, wherein the PLMN search comprises one or more frequency scans.

In some implementations, the method further involves performing the PLMN search on available frequency bands that are not currently being used by the first connection instance or that are not in band conflict with the first connection instance; and identifying a first subset of PLMN search results detected on the available frequency bands.

In some implementations, the method further involves determining that the first connection instance is in RRC idle mode; responsively performing, using the first or second connection instance, the PLMN search on a remaining set of frequency bands; and identifying a second subset of PLMN search results detected on the remaining set of frequency bands.

In some implementations, the method further involves determining that the first connection instance is in RRC idle mode; and responsively performing at least one remaining frequency scan on the first connection instance.

In some implementations, the method further involves determining that the second connection instance is unavailable for the PLMN search; and responsively aborting the PLMN search on the second connection instance.

In some implementations, the method further involves identifying PLMNs found on searched frequency bands prior to aborting the PLMN search.

In some implementations, the method further involves resuming the PLMN search on the first connection instance.

In some implementations, the apparatus is a user equipment (UE) or a baseband processor.

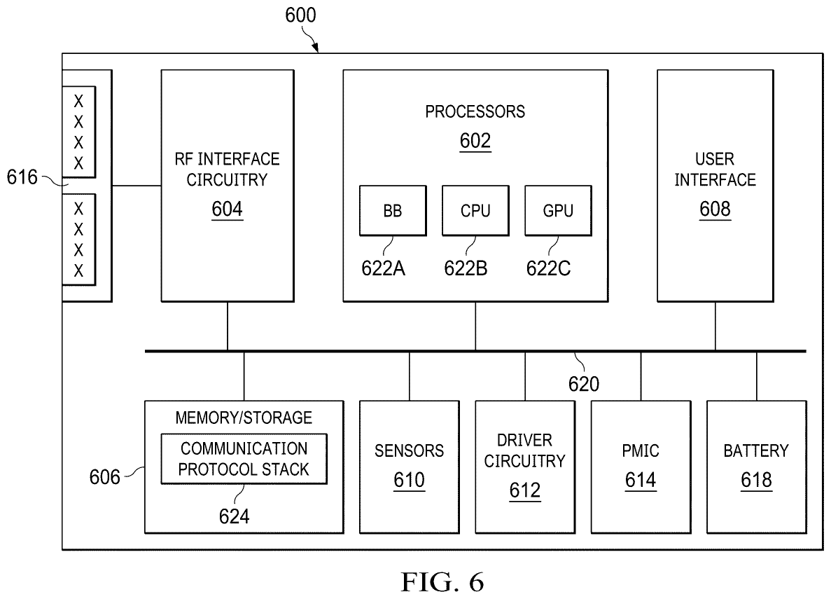

FIG. 6 illustrates an example UE 600, according to some implementations. The UE 600 may be similar to and substantially interchangeable with UE 102 of FIG. 1.

The UE 600 may be any mobile or non-mobile computing device, such as, for example, mobile phones, computers, tablets, wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, one or more antenna(s) 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves into electrical signals. The antenna elements may be arranged into one or more antenna panels. The antenna(s) 616 may have antenna panels that are omnidirectional, directional, or a combination thereof to enable beamforming and multiple input, multiple output communications. The antenna(s) 616 may include microstrip antennas, printed antennas fabricated on the surface of one or more printed circuit boards, patch antennas, phased array antennas, etc. The antenna(s) 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

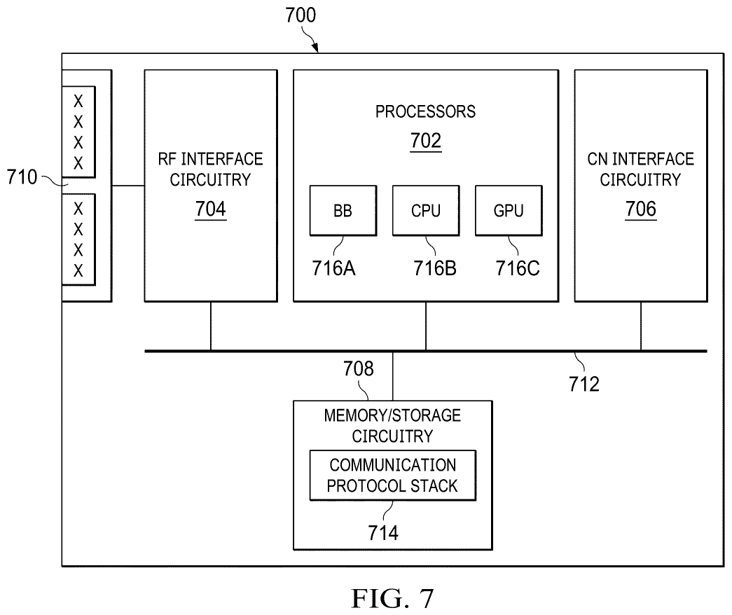

FIG. 7 illustrates an example access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and one or more antenna(s) 710.

The components of the access node 700 may be coupled with various other components over one or more interconnects 712. The processors 702, RF interface circuitry 704, memory/storage circuitry 708 (including communication protocol stack 714), antenna(s) 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

Example 1 is a user equipment (UE) including: one or more processors; and memory storing instructions that when executed by the one or more processors, cause the UE to perform operations including: receiving, by an access stratum (AS) layer of the UE and from a non-access stratum layer (NAS) layer of the UE, a Public Land Mobile Network (PLMN) search request; determining, by the AS layer, that a first connection instance is in radio resource control (RRC) connected mode; responsively determining, by the AS layer, whether a second connection instance is available; and in response to determining that the second connection instance is available, triggering, by the AS layer, the PLMN search on the second connection instance, wherein the PLMN search comprises one or more frequency scans.

Example 2 is the UE of example 1, where the one or more frequency scans comprise at least one of a short list search (SLS) scan, a derived band search (DBS) scan, or a remaining band search (RBS) scan.

Example 3 is the UE of example 1, the operations further including: performing, by the AS layer and using the second connection instance, the PLMN search on available frequency bands that are not currently being used by the first connection instance or that are not in band conflict with the first connection instance; and providing, by the AS layer and to the NAS layer, a first set of PLMN search results detected on the available frequency bands.

Example 4 is the UE of example 3, the operations further including: determining, by the AS layer, that the first connection instance has transitioned to an RRC idle mode; responsively performing, by the AS layer and using the first or second connection instance, the PLMN search on a remaining set of frequency bands; and providing, by the AS layer and to the NAS layer, a second set of PLMN search results detected on the remaining set of frequency bands.

Example 5 is the UE of example 1, the operations further including: determining, by the AS layer and during the PLMN search, that the first connection instance has transitioned to an RRC idle mode; and responsively triggering, by the AS layer, at least one remaining frequency scan using the first connection instance.

Example 6 is the UE of example 1, the operations further including: detecting, by the AS layer, an activity on the second connection instance different from the PLMN search; and responsively aborting the PLMN search on the second connection instance.

Example 7 is the UE of example 6, the operations further including: sending, by the AS layer to the NAS layer, a message comprising: (i) an indication of frequency bands searched prior to aborting the PLMN search, and (ii) a list of identified PLMNs on the searched frequency bands.

Example 8 is the UE of example 6, the operations further including: resuming the PLMN search on the first connection instance.

Example 9 is the UE of example 1, where the first connection instance is for a first radio access technology (RAT) and the second connection instance is for a second RAT.

Example 10 is the UE of example 1, where the UE is a Multi-Subscriber Identity Module (MSIM) UE.

Example 11 is the UE of example 1, where the first connection instance is provided by a first SIM and the second connection instance is provided by a second SIM.

Example 12 is an apparatus including: processing circuitry configured to perform operations including: determining to perform a Public Land Mobile Network (PLMN) search on a first connection instance; determining that the first connection instance is in radio resource control (RRC) connected mode; determining whether a second connection instance is available for the PLMN search; and in response to determining that the second connection instance is available, performing the PLMN search on the second connection instance, wherein the PLMN search comprises one or more frequency scans.

Example 13 is the apparatus of example 12, the operations further including: performing the PLMN search on available frequency bands that are not currently being used by the first connection instance or that are not in band conflict with the first connection instance; and identifying a first subset of PLMN search results detected on the available frequency bands.

Example 14 is the apparatus of example 12, the operations further including: determining that the first connection instance is in RRC idle mode; responsively performing, using the first or second connection instance, the PLMN search on a remaining set of frequency bands; and identifying a second subset of PLMN search results detected on the remaining set of frequency bands.

Example 15 is the apparatus of example 12, the operations further including: determining that the first connection instance is in RRC idle mode; and responsively performing at least one remaining frequency scan on the first connection instance.

Example 16 is the apparatus of example 12, the operations further including: determining that the second connection instance is unavailable for the PLMN search; and responsively aborting the PLMN search on the second connection instance.

Example 17 is the apparatus of example 16, the operations further including: identifying PLMNs found on searched frequency bands prior to aborting the PLMN search.

Example 18 is the apparatus of example 16, the operations further including: resuming the PLMN search on the first connection instance.

Example 19 is the apparatus of example 12, where the apparatus is a user equipment (UE) or a baseband processor.

Example 20 may include one or more non-transitory computer-readable media including instructions to cause an electronic device, upon execution of the instructions by one or more processors of the electronic device, to perform one or more elements of operations described in or related to any of examples 1-19, or any other method or process described herein.

Example 21 may include an apparatus including logic, modules, and/or circuitry (e.g., processing circuitry) to perform one or more elements of the operations described in or related to any of examples 1-19, or any other method or process described herein.

Example 22 may include a method, technique, or process as described in or related to any of examples 1-19, or portions or parts thereof.

Example 23 may include an apparatus including: one or more processors and one or more computer-readable media including instructions that, when executed by the one or more processors, cause the one or more processors to perform the operations, techniques, or process as described in or related to any of examples 1-19, or portions thereof.

Example 24 may include a method of communicating in a wireless network as shown and described herein.

Example 25 may include a system for providing wireless communication as shown and described herein.

Example 26 may include a device for providing wireless communication as shown and described herein. The operations or actions performed by the device can include the operations of any one of examples 1-19.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A user equipment (UE) comprising:
one or more processors; and
memory storing instructions that when executed by the one or more processors, cause the UE to perform operations comprising:
receiving, by an access stratum (AS) layer of the UE and from a non-access stratum layer (NAS) layer of the UE, a Public Land Mobile Network (PLMN) search request;
determining, by the AS layer, that a first connection instance is in radio resource control (RRC) connected mode;
responsively determining, by the AS layer, whether a second connection instance is available; and
in response to determining that the second connection instance is available, triggering, by the AS layer, the PLMN search on the second connection instance, wherein the PLMN search comprises one or more frequency scans.

2. The UE of claim 1, wherein the one or more frequency scans comprise at least one of a short list search (SLS) scan, a derived band search (DBS) scan, or a remaining band search (RBS) scan.

3. The UE of claim 1, the operations further comprising:
performing, by the AS layer and using the second connection instance, the PLMN search on available frequency bands that are not currently being used by the first connection instance or that are not in band conflict with the first connection instance; and
providing, by the AS layer and to the NAS layer, a first set of PLMN search results detected on the available frequency bands.

4. The UE of claim 3, the operations further comprising:
determining, by the AS layer, that the first connection instance has transitioned to an RRC idle mode;
responsively performing, by the AS layer and using the first or second connection instance, the PLMN search on a remaining set of frequency bands; and
providing, by the AS layer and to the NAS layer, a second set of PLMN search results detected on the remaining set of frequency bands.

5. The UE of claim 1, the operations further comprising:
determining, by the AS layer and during the PLMN search, that the first connection instance has transitioned to an RRC idle mode; and
responsively triggering, by the AS layer, at least one remaining frequency scan using the first connection instance.

6. The UE of claim 1, the operations further comprising:
detecting, by the AS layer, an activity on the second connection instance different from the PLMN search; and
responsively aborting the PLMN search on the second connection instance.

7. The UE of claim 6, the operations further comprising:
sending, by the AS layer to the NAS layer, a message comprising: (i) an indication of frequency bands searched prior to aborting the PLMN search, and (ii) a list of identified PLMNs on the searched frequency bands.

8. The UE of claim 6, the operations further comprising:
resuming the PLMN search on the first connection instance.

9. The UE of claim 1, wherein the first connection instance is for a first radio access technology (RAT) and the second connection instance is for a second RAT.

10. The UE of claim 1, wherein the UE is a Multi-Subscriber Identity Module (MSIM) UE.

11. The UE of claim 1, wherein the first connection instance is provided by a first SIM and the second connection instance is provided by a second SIM.

12. An apparatus comprising:
processing circuitry configured to perform operations comprising:
determining to perform a Public Land Mobile Network (PLMN) search on a first connection instance;
determining that the first connection instance is in radio resource control (RRC) connected mode;
determining whether a second connection instance is available for the PLMN search; and
in response to determining that the second connection instance is available, performing the PLMN search on the second connection instance, wherein the PLMN search comprises one or more frequency scans.

13. The apparatus of claim 12, the operations further comprising:
performing the PLMN search on available frequency bands that are not currently being used by the first connection instance or that are not in band conflict with the first connection instance; and
identifying a first subset of PLMN search results detected on the available frequency bands.

14. The apparatus of claim 12, the operations further comprising:
determining that the first connection instance is in RRC idle mode;
responsively performing, using the first or second connection instance, the PLMN search on a remaining set of frequency bands; and
identifying a second subset of PLMN search results detected on the remaining set of frequency bands.

15. The apparatus of claim 12, the operations further comprising:
determining that the first connection instance is in RRC idle mode; and
responsively performing at least one remaining frequency scan on the first connection instance.

16. The apparatus of claim 12, the operations further comprising:
determining that the second connection instance is unavailable for the PLMN search; and
responsively aborting the PLMN search on the second connection instance.

17. The apparatus of claim 16, the operations further comprising:
identifying PLMNs found on searched frequency bands prior to aborting the PLMN search.

18. The apparatus of claim 16, the operations further comprising:
resuming the PLMN search on the first connection instance.

19. The apparatus of claim 12, wherein the apparatus is a user equipment (UE) or a baseband processor.

20. A method comprising:
determining to perform a Public Land Mobile Network (PLMN) search on a first connection instance;
determining that the connection instance is in radio resource control (RRC) connected mode;
determining whether a second connection instance is available for the PLMN search; and
in response to determining that the second connection instance is available, performing the PLMN search on the second connection instance, wherein the PLMN search comprises one or more frequency scans.
